(19) United States
(12) Patent Application Publication
(10) Pub. No.: US 2012/0076275 A1
(43) Pub. Date: Mar. 29, 2012

(54) RADIOGRAPHIC IMAGING APPARATUS AND RADIOGRAPHIC IMAGING METHOD AND PROGRAM

(75) Inventors: Noriaki Ida, Kanagawa (JP); Hirofumi Sawada, Kanagawa (JP); Akiko Kanagawa, Kanagawa (JP); Daiki Harada, Kanagawa (JP); Satomi Yamada, Kanagawa (JP); Minoru Takami, Kanagawa (JP); Yasunori Ohta, Kanagawa (JP); Naoki Mochizuki, Kanagawa (JP); Ryo Ono, Kanagawa (JP)

(73) Assignee: Fujifilm Corporation, Tokyo (JP)

(21) Appl. No.: 13/240,997

(22) Filed: Sep. 22, 2011

(30) Foreign Application Priority Data
Sep. 29, 2010 (JP) 2010-218870

(51) Int. Cl. H05G 1/64

(52) U.S. Cl. 378/98.8

(57) ABSTRACT

A radiographic imaging apparatus with which the rotation amount of acquired radiographs can be the same in comparative interpretation of these images. The radiographic imaging apparatus includes an imaging unit for emitting radiation from a radiation source to a subject and detecting radiation having passed through the subject with a radiation detector having sensors arrayed therein to acquire a radiographic image, an image processor for performing rotation processing on the radiographic image to produce an acquired radiograph and collateral information of the acquired radiograph, a storage unit for storing the acquired radiograph and the collateral information, and a monitor for displaying the acquired radiograph. The collateral information contains the direction in which the sensors are arrayed and a rotation angle used in the rotation processing and is correlated to the acquired radiograph.

### BACKGROUND OF THE INVENTION

The present invention relates to a radiographic imaging apparatus for acquiring a radiographic image of a subject and a radiographic imaging method and program, and particularly to a radiographic imaging apparatus and a radiographic imaging method and program wherein the direction in which the sensors of the radiation detector are arrayed is stored in association with each radiographic image.

In X-ray imaging in the medical field, the collimator, which narrows its aperture manually or automatically to adjust X-ray radiation, is controlled to reduce X-ray dosage to which the subject is exposed. In recent years, an X-ray imaging apparatus that uses a flat panel display is used to obtain a digital X-ray image and in which the collimator is controlled so that only a region that needs to be exposed is irradiated with X-ray to limit the range of the radiation field. For collimator control, there has been proposed a method whereby the relationship between subject, radiation source, and aperture narrowing amount is stored and reproduced when imaging is performed the next time.

Further, when the subject is positioned at an angle with respect to the sides of the FPD, the image acquired is rotated using an image indicating means, and only a portion necessary for diagnosis is trimmed to obtain an easy-to-see diagnostic image.

JP 2002-8008 A, for example, describes a medical image outputting method comprising specifying a rotation angle used in rotation processing for rotating a medical image, rotating the medical image by the specified rotation angle in the rotation processing, and outputting the medical image having undergone the rotation processing to an image output medium having a rectangular output area.

JP 2002-368975 A describes an image processing apparatus performing image data conversion so that, in an image trimming processing, the image rotates, in an image processing apparatus for processing image data containing an image of at least a part of a human body.

### SUMMARY OF THE INVENTION

The sensors of the FPD are arranged in a lattice-like pattern such that the pixels of an acquired radiograph correspond to the sensors. When the rotation processing is applied to an acquired radiograph as in JP 2002-8008 A, the pixel data of the acquired radiograph exhibits one-to-one correspondence with the pixel data after rotation by angles of 90°, 180°, and 270°, whereas by rotation of the other angles, it is necessary to produce fresh pixel data from the pixel data of the original radiograph by interpolation. Thus, the pixel data of the acquired radiograph is changed from the pixel value of the original image, and hence the image quality may change.

Further, should the rotation angle or direction differ between previous and present radiographs in comparative interpretation of the same site of the same patient represented in the previous and present radiographs for follow-up observation, for example, different interpolation calculations are performed also for rotation processing between the previous and present radiographs, which means that the comparison is made between radiographs having different image qualities so that problems sometimes have been thereby caused.

An object of the present invention is to provide a radiographic imaging apparatus and a radiographic imaging method and program wherein the sensor array direction is stored in association with each radiographic image so that the relationship between the direction in which the sensors of the radiation detector are arrayed and the direction of the subject coincides between a previous radiograph and a present radiograph and that, accordingly, the rotation amounts of the radiographs for comparative interpretation may be identical.

In order to attain the object described above, the present invention provides a radiographic imaging apparatus comprising:

an imaging unit for emitting radiation from a radiation source to a subject and detecting radiation having passed through the subject with a radiation detector including sensors arrayed therein to acquire a radiographic image,

an image processor for performing rotation processing on the radiographic image to produce an acquired radiograph and collateral information of the acquired radiograph,

a storage unit for storing the acquired radiograph and the collateral information, and

a monitor for displaying the acquired radiograph,

wherein the collateral information contains the direction in which the sensors are arrayed and a rotation angle used in the rotation processing and is correlated to the acquired radiograph.

Also, the present invention provides a radiographic imaging method comprising:

an image acquiring step of obtaining a radiographic image which is acquired by emitting radiation from a radiation source to a subject and detecting radiation having passed through the subject with a radiation detector having sensors arrayed therein,

an image processing step of performing rotation processing on the radiographic image to produce an acquired radiograph and collateral information of the acquired radiograph, and

a storing step of storing the acquired radiograph and the collateral information containing a sensor array direction and a rotation angle used in the rotation processing, the collateral information being correlated to the acquired radiograph, and

a displaying step of displaying the acquired radiograph.

Also, the present invention provides a non-transitory computer readable recording medium having therein stored a program for causing a computer to execute the steps in the radiographic imaging method described above.

The present invention enables acquisition of radiographs wherein the relationship between the sensor array direction and the subject coincide between a previous radiograph and a present radiograph and that, accordingly, the rotation amounts of the radiographs for comparative interpretation may be identical.

### BRIEF DESCRIPTION OF THE DRAWINGS

FIG. 1 is a block diagram illustrating the radiographic imaging apparatus of the invention.

FIG. 2 is a flowchart illustrating an example of a processing flow in imaging.

FIG. 3 is an explanatory view illustrating an example of a display illustrating a previous radiograph and a sensor array direction.

FIG. 4 is an explanatory view illustrating an example of a sensor array direction and a rotation/trimming processing.

FIG. 5 is an explanatory view illustrating an example of a relationship between a sensor array direction and a direction of a subject, and a rotation/trimming processing.

### DETAILED DESCRIPTION OF THE INVENTION

The radiographic imaging apparatus of the invention for implement a radiographic imaging method of the invention will be described in detail below based upon preferred embodiments illustrated in the attached drawings.

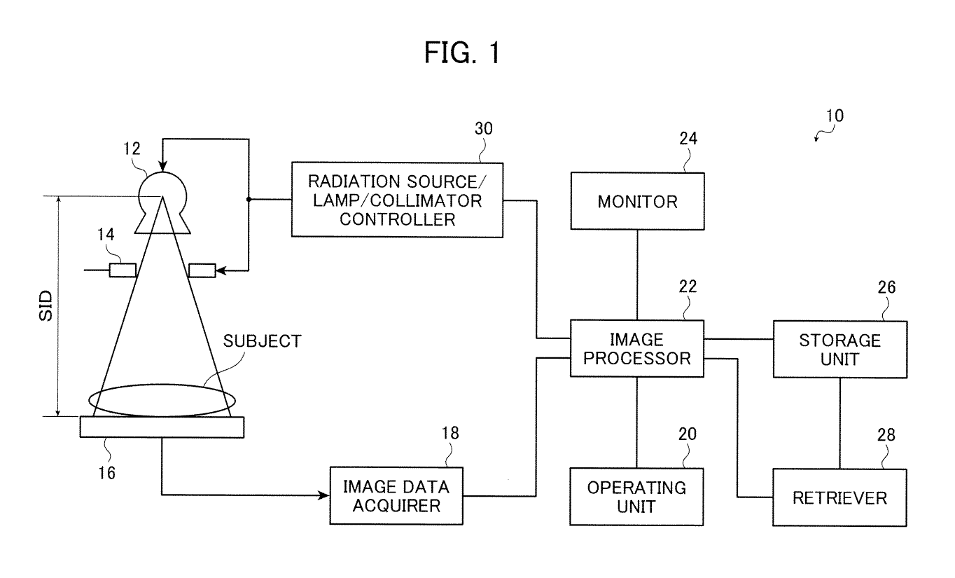

FIG. 1 is a block diagram of an embodiment representing a configuration of a radiographic imaging apparatus according to the invention.

A radiographic imaging apparatus 10 illustrated in FIG. 1 comprises radiation source/lamp unit 12, a collimator 14, an FPD 16, an image data acquirer 18, an operating unit 20, an image processor 22, a monitor 24, a storage unit 26, a retriever 28, and a radiation source/lamp/collimator controller 30.

The radiation source/lamp unit 12 comprises an X-ray tube for radiating X-ray where it uses X-ray as radiation and a lamp for projecting the radiation field region by illuminating the radiation field with visible light before imaging. The radiation source/lamp unit 12 is controlled by the radiation source/lamp/collimator controller 30 described later and radiates X-ray and/or visible light where necessary.

The radiation source/lamp unit 12 comprises a sensor array direction indication means for indicating the array direction of the sensors in the FPD 16 described later in a previous radiograph. The sensor array direction indication means may comprise a light source such as laser and radiates visible light to project the sensor array direction on the subject (imaging table) with an arrow or other means.

The radiation source/lamp unit 12 comprises a subject profile information indicating means for showing subject profile information indicating the position of a subject in a previous radiograph. The subject profile information indicating means may use a light source such as laser as does the sensor array direction indication means and projects subject profile information onto the subject (imaging table). When, for example, a previous radiograph represents a hand, the profile of the hand can be projected. The sensor array direction indication means and the subject profile information indicating means may share the same light source or may each have a separate light source.

The collimator 14 comprises an aperture for controlling the radiation field region covered by the radiation (X-ray) and has a plurality of collimator blades. The collimator 14 may for example comprise an aperture formed by four collimator blades so arranged to form the sides of a quadrangle.

The FPD 16 is a radiation detector used in a DR type (digital radiography) and detects radiation having passed through the subject. The FPD 16 is disposed in a position opposite the radiation source/lamp unit 12 and the collimator 14. These components constitute an imaging means. Examples of such DR type imaging unit include a fixed type having the FPD incorporated in a standing-position imaging table or a lying-position imaging table and a transportable type having the FPD housed in a cassette and attached to the imaging unit when imaging is performed.

In lieu of the FPD 16 may be used a CR (computer aided radiography) type imaging unit wherein radiation having passed through the subject is stored in an imaging plate (IP), which is then scanned using a laser beam, and photo-stimulated luminescence fluorescent light then emitted from the IP is read and computer-processed to obtain image data.

The image data acquirer 18 reads out the data read from the FPD 16 to output digital image data of a radiographic image. The vertical direction and the horizontal direction of digital image data obtained at this point of time are outputted as sensor array direction information (X-axis and Y-axis of the image).

When an IP is used in lieu of the FPD 16, the IP is laser-scanned to read the photo-stimulated luminescence to output the digital image data and sensor array direction information of the radiographic image. The vertical direction and the horizontal direction of digital image data obtained using the IP are also regarded as the sensor array directions as in the case of the FPD. With the IP, the sensor array directions may be defined as the IP travel direction during reading processing and the direction perpendicular thereto. Two sensor array directions are defined with the FPD and the IP as above, these two directions being perpendicular to each other at all times. Accordingly, storing only one of them suffices for the other to be determined automatically. Thus, “sensor array direction” mentioned without distinction refers to at least one of the two directions herein below.

The operating unit 20 is an input means provided for, for example, an imaging technician to operate the radiographic imaging apparatus 10. The operating unit 20 outputs operation information. The operating unit 20 is not specifically limited and known operating equipment may be used such as keyboard, mouse, touch panel, and the like.

The image processor 22 is inputted with digital image data of the radiographic image, sensor array direction information, operation information, and retrieval results described later. The operation information includes information on the subject (subject information) and imaging menu information for determining imaging conditions, both information being entered by, for example, an imaging technician; the retrieval results include a previous radiograph and subject information, sensor array direction, information on a rotation angle in the rotation processing, subject profile information, and imaging menu information of the previous radiograph.

The image processor 22 is an image processing means and produces and outputs an acquired radiograph obtained by applying rotation processing, trimming processing, and other image processing to digital image data of a radiographic image and collateral information. The image processor 22 also outputs, for example, the name and ID of a subject contained in the operation information. The collateral information includes information on the direction in which the sensors are arrayed in the FPD 16 and information on the rotation angle in the rotation processing. The collateral information may contain subject profile information that is information on the profile of a subject detected from a radiograph.

The image processor 22 outputs a previous radiograph entered as retrieval result to the monitor 24.

The image processor 22 further outputs imaging control information, which is control information on the radiation source, the radiation field lamp, and the collimator, in order to control the radiation source/lamp/collimator controller 30.

The monitor 24 receives and displays, for example, an acquired radiograph and/or a previous radiograph. The monitor 24 is a flat panel display such as, for example, a liquid crystal display, a plasma display, or an organic EL (electro-luminescence) display or a CRT (Cathode Ray Tube).

The storage unit 26 receives and stores an acquired radiograph, subject information, imaging menu information, and collateral information. The acquired radiograph is stored in association with the imaging menu information including imaging conditions of the acquired radiograph, subject information including subject's ID, name, age, sex, and imaged site, and collateral information.

The retriever 28 is inputted with subject information. The retriever 28 searches the storage unit 26 based on the subject information and, upon finding pertinent subject information, reads out a previous radiograph of the subject and other subject information, imaging menu information, and collateral information correlated with the acquired radiograph from the storage unit 26 and outputs them as retrieval results. When no pertinent subject information is found, a retrieval result to that effect is read out.

The radiation source/lamp/collimator controller 30 is inputted with imaging control information. The radiation source/lamp/collimator controller 30 is inputted with the sensor array direction information and/or subject profile information of a previous radiograph.

The radiation source/lamp/collimator controller 30 is a radiation field control means that controls the collimator so that radiation and visible light of the lamp irradiate only a given region. The radiation source/lamp/collimator controller 30 further controls on-off operation of the radiation field lamp, irradiation from the radiation source, and positioning of the radiation source/lamp unit 12 and the FPD 16 according to the imaging control information.

Further, when the sensor array direction information and/or subject profile information is entered in the radiation source/lamp/collimator controller 30, the sensor array direction information and/or subject profile is projected on displayed on the subject or the imaging table through the sensor array direction indication means and/or subject profile information indication means such as a laser and a projector, not shown, provided between the collimator 14 and the subject.

Next, the operation of the radiographic imaging apparatus 10 of the invention for implementing the radiographic imaging method of the invention will be described.

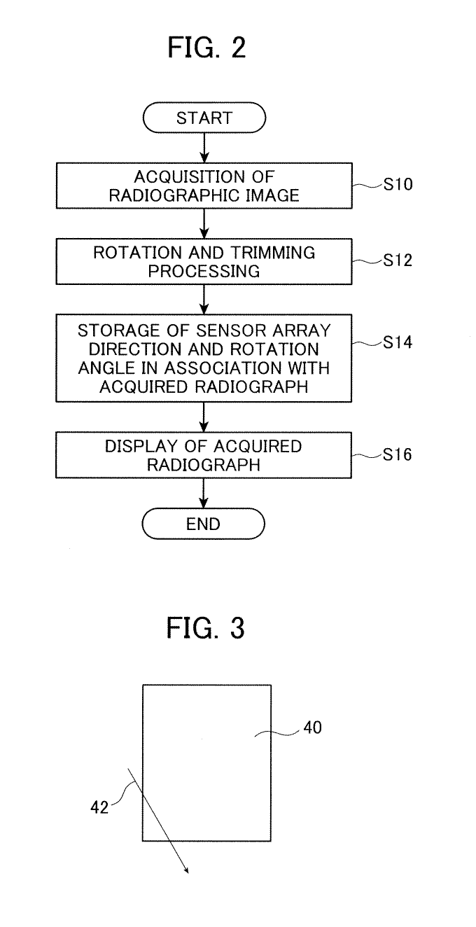

FIG. 2 is a flowchart illustrating an example of a processing flow in the radiographic imaging method of the invention.

The imaging technician enters subject information such as the subject's ID, name, age, sex, and imaged site, the positions of the radiation source/lamp unit 12 and the imaging table having the FPD 16 set therein and the aperture of the collimator 14 are adjusted manually, whereupon verification is made as to whether a given region is illuminated by the radiation field lamp, followed by irradiation to obtain an acquired radiograph (step S10).

When there is a previous radiograph of the subject now to be imaged, and the sensor array direction information and/or subject profile information is stored in association with the previous radiograph, the sensor array direction indication means and/or subject profile information indication means projects the sensor array direction and/or subject profile onto the subject or the imaging table.

The subject is located in a given position of the imaging table by the imaging technician referring to the projected sensor array direction and/or subject profile.

As illustrated in FIG. 3, a sensor array direction 42 and/or the subject profile may be displayed on the monitor 24 with a previous radiograph 40 or may be displayed on a portable information terminal when imaging is performed using a portable radiographic imaging apparatus.

Digital image data and sensor array direction information of an acquired radiographic image are outputted from the image data acquirer 18 and inputted in the image processor 22. The image processor 22 performs rotation processing, trimming processing, and other image processing on the digital image data of the radiographic image to produce an acquired radiograph (step S12).

Subsequently, imaging menu information, which includes imaging conditions of the acquired radiograph, subject information, and collateral information including sensor array direction information and rotation angle information are stored in the storage unit 26 in association with the acquired radiograph (step S14), and the acquired radiograph is displayed on the monitor 24 (step S16).

Now, the rotation processing and trimming processing performed in steps S12 and S14 and the relationship between sensor array direction information and rotation angle information, which are collateral information, on the one hand and the acquired radiograph on the other hand will be described referring to specific examples.

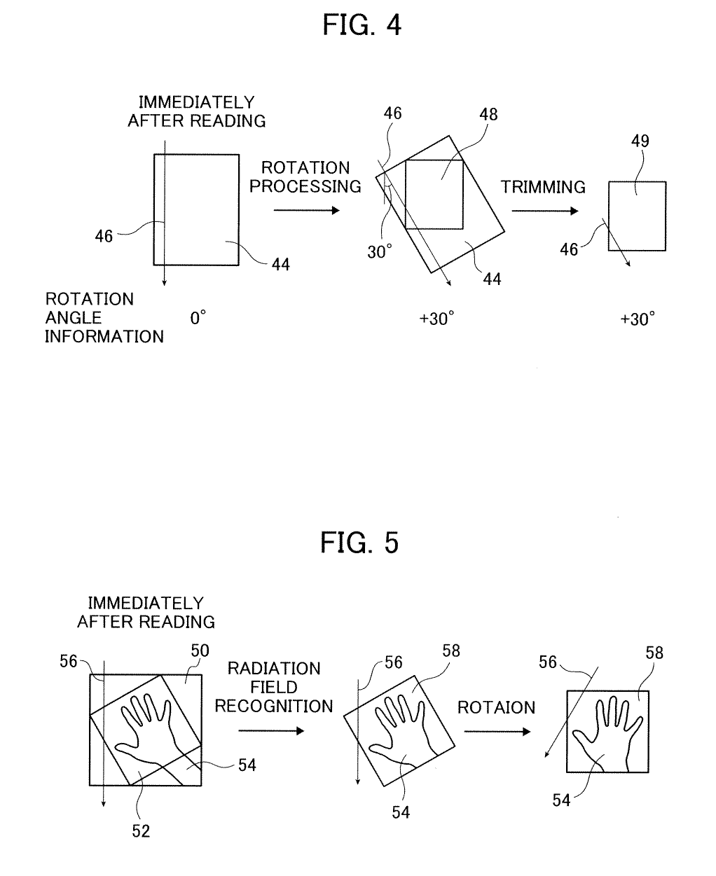

Referring to FIG. 4, description will be made of a case where rotation processing and trimming processing are performed on a radiographic image immediately after digital image data of the radiographic image is entered in the image processor 22, i.e., immediately after the reading.

First, a radiographic image 44 as of the time immediately following the reading is rotated 30° counterclockwise, for example, in the rotation processing so that the subject is easy to view. Then, the sensor array direction is also rotated 30° counterclockwise. Form the information of 30° counterclockwise, which is a rotation angle in the rotation processing, the rotation angle information is generated.

Then, a trimming region 48 is entered by the imaging technician, and trimming processing is performed to produce an acquired radiograph 49. The sensor array direction 46 is also retained with respect to the acquired radiograph 49, and the sensor array direction information is generated.

The sensor array direction information and the rotation angle information are stored in the storage unit 26 as collateral information in association with the acquired radiograph 49. The collateral information may be displayed on the monitor 24 together with the acquired radiograph 49.

Next, reference is made to FIG. 5 to describe a case where radiation field recognition processing is performed on an acquired radiograph as of the time immediately after the reading, and the radiation field is trimmed by trimming processing, followed by the rotation processing.

First, a radiation field region 52, which is an irradiated region in a subject 54, is recognized in an acquired radiograph 50 as of the time immediately after the reading, and trimmed by trimming processing to generate an acquired radiograph 58. The sensor array direction 56 is also retained with respect to the acquired radiograph 58, and the sensor array direction information is generated. Automatic radiation field recognition processing may be carried out using a known technique as described in, for example, JP 63-259538 A, and therefore description of any specific method therefor is not herein made.

The acquired radiograph 58 is then rotated clockwise so as to be easy to view, that is, in such a manner that when the acquired radiograph 58 is displayed on the monitor 24, the side thereof adjacent the wrist of the subject 54 lies horizontally. The rotation angle information is produced from the rotation angle as of this time and stored together with the sensor array direction information in the storage unit 26 as collateral information in association with the acquired radiograph 58. The collateral information may be displayed on the monitor 24 together with the acquired radiograph 58.

As described above, the sensor array direction information and/or subject profile information is stored and projected onto the subject or the imaging table or displayed on the monitor for the imaging technician to refer to thereby to enable acquisition of an acquired radiograph having the same relationship between the sensor array direction and the subject as does a previous radiograph, so that in comparison between the previous and present radiographs the rotation amount for both the radiographs may be identical.

All the above examples presuppose that both rotation processing and trimming processing are performed on the assumption that that the procedure involves a generally followed flow from radiography to reading of an acquired radiograph. However, the present invention may also be applied to a flow involving only the rotation processing without trimming processing performed on the original image. In this case, the smallest rectangle circumscribed about the original image having undergone only rotation processing and no trimming processing is produced (the longitudinal direction of that rectangle being the vertical direction of the monitor screen and the lateral direction being the horizontal direction of the monitor screen), and outputted as the radiograph.

Where there are two or more diagnostic images previously acquired, the latest or the last acquired diagnostic image may be used as a basis for projecting or displaying the sensor array direction information and/or subject profile information, or the sensor array direction information and/or the subject profile information that are largest in number may be projected or displayed.

When the sensor array direction information and/or the subject profile information is projected onto the subject (imaging table), the aperture size of the collimator to which the aperture was adjusted at the time when a previous radiograph was acquired, i.e., the region illuminated by the radiation field lamp, may also be displayed.

The sensor array direction information and/or the subject profile information may be displayed by a second display means provided in the imaging table.

When imaging was performed by a radiographic imaging apparatus wherein the FPD can be rotated with respect to the radiation source, imaging can be performed with the same radiation field and slope by recording the rotation angles of the radiation field aperture (collimator), the subject, and the FPD together with the radiograph. Alternatively, the FPD and the radiation field aperture may be associated, so that the angle formed by the radiation field and the FPD remain unchanged at all times. Alternatively, an alert may be displayed before imaging so that rotation of an acquired radiograph may be saved whenever possible.

The invention may be configured into a radiographic imaging program for causing a computer to execute the steps in the above radiographic imaging method or a radiographic imaging program for causing a computer to function as individual means for implementing the steps in the radiographic imaging method, or for causing a computer to function as individual means for configuring components of the above radiographic imaging apparatus.

Further, the above radiographic imaging program of the present invention may be configured as a computer-readable medium or as a computer-readable memory.

While the radiographic imaging apparatus and the radiographic imaging method and program of the present invention have been described in detail, the above embodiments are only illustrative and various changes and modifications may be made without departing from the true spirit and scope of the invention.

What is claimed is:

1. A radiographic imaging apparatus comprising:
an imaging unit for emitting radiation from a radiation source to a subject and detecting radiation having passed through the subject with a radiation detector including sensors arrayed therein to acquire a radiographic image,
an image processor for performing rotation processing on the radiographic image to produce an acquired radiograph and collateral information of the acquired radiograph,
a storage unit for storing the acquired radiograph and the collateral information, and
a monitor for displaying the acquired radiograph,
wherein the collateral information contains the direction in which the sensors are arrayed and a rotation angle used in the rotation processing and is correlated to the acquired radiograph.

2. The radiographic imaging apparatus according to claim 1, wherein together with a previous radiograph stored in the storage unit, a previous sensor array direction as of time when the previous radiograph was acquired is displayed on the monitor.

3. The radiographic imaging apparatus according to claim 2, wherein the previous radiograph and the previous sensor array direction are displayed on the monitor in juxtaposition with the acquired radiograph and the sensor array direction on the monitor.

4. The radiographic imaging apparatus according to claim 2, wherein the previous sensor array direction and the sensor array direction are aligned to display the previous radiograph and the acquired radiograph on the monitor.

5. The radiographic imaging apparatus according to claim 4, wherein the previous radiograph and the acquired radiograph are displayed by superposition on the monitor.

6. The radiographic imaging apparatus according to claim 1, wherein a previous sensor array direction corresponding to a previous radiograph stored in the storage unit is displayed on the monitor by superposition on the acquired radiograph and the sensor array direction.

7. The radiographic imaging apparatus according to claim 1,
wherein the imaging unit further comprises a radiation field lamp and a sensor array direction indicator,
wherein the collateral information further contains an aperture narrowing amount for controlling an amount of radiation from the radiation source, and
wherein the aperture narrowing amount as of time when the previous radiograph was acquired is projected onto an imaging table using the radiation field lamp and a sensor array direction is projected onto the imaging table using the sensor array direction indicator.

8. The radiographic imaging apparatus according to claim 1,
wherein the imaging unit further comprises a radiation field lamp and a subject profile information indicator,
wherein the collateral information further contains an aperture narrowing amount for controlling an amount of radiation from the radiation source and subject profile information, and
wherein the aperture narrowing amount as of time when the previous radiograph was acquired is projected onto an imaging table using the radiation field lamp and the subject profile information is projected onto the imaging table using the subject profile information indicator.

9. A radiographic imaging method comprising:
an image acquiring step of obtaining a radiographic image which is acquired by emitting radiation from a radiation source to a subject and detecting radiation having passed through the subject with a radiation detector having sensors arrayed therein,
an image processing step of performing rotation processing on the radiographic image to produce an acquired radiograph and collateral information of the acquired radiograph, and
a storing step of storing the acquired radiograph and the collateral information containing a sensor array direction and a rotation angle used in the rotation processing, the collateral information being correlated to the acquired radiograph, and
a displaying step of displaying the acquired radiograph.

10. A non-transitory computer readable recording medium having therein stored a program for causing a computer to execute the steps in the radiographic imaging method described in claim 9.
